(19) United States
(12) Patent Application Publication
(10) Pub. No.: US 2011/0074167 A1
(43) Pub. Date: Mar. 31, 2011

(54) DOOR LATCH

(76) Inventors: Curtis Taufman, Melville, NY (US); Anthony Piscitelli, Long Beach, NY (US)

(21) Appl. No.: 11/853,810

(22) Filed: Sep. 11, 2007

Related U.S. Application Data
(60) Provisional application No. 60/825,199, filed on Sep. 11, 2006.

(51) Int. Cl. E05C 19/06; E05B 3/00

(52) U.S. Cl. 292/83; 292/336.3

(57) ABSTRACT

A door latching system for securing an armored door or window includes a latch assembly which is bolted to the interior of an armored door, a handle assembly which is welded to the exterior of the armored door and a strike plate which is welded to a vehicle structure or an armored side plate. The latch functions by moving an interior handle or an exterior handle in a rotary motion, which rotates a square key stock to which a cam is attached that retracts a latch. The latch is spring-loaded which allows the latch to extend to its original position when a handle is released. The springs also move the handles back to their original locations when released. When the door is shut the latch is pushed back by the strike plate, which moves the latch away from the cam, thus allowing the door to close and latch without movement of the handles. The strike plate has a roller mounted on it, which allows the latch to roll on it when the door is closed. An optional locking system allows the latching system to be secured in a latched or locked position such that the door or window to which it attached may only be readily opened from inside the vehicle.

### CROSS-REFERENCE TO CORRESPONDING APPLICATIONS

This application takes priority from provisional patent application Ser. No. 60/825,199 filed on Sep. 11, 2006. The legal benefit and priority of the previously filed application is expressly claimed.

### TECHNICAL FIELD

The present invention relates generally to latching mechanisms and is directed particularly to latching mechanisms for egress/ingress door and window assemblies, particularly those door and window assemblies used in military combat vehicles wherein the proper performance of said latching mechanisms is critical to the protection of the occupants therein.

### BACKGROUND OF THE INVENTION

### Background Art

It is an undisputed fact today that military combat personnel routinely encounter many threatening situations and perilous circumstances which are potentially injurious, if not actually life endangering. Exemplifying some of these precarious incidents are the perilous and frequently tragic danger to human life and limb caused by enemy combatants, improvised exploding devices, bombs and other detonated explosives, shells and grenades of terrorist attacks; and the always-present dangers and often imminent vulnerabilities to the bodies and lives of soldiers, sailors, and airmen caused by modern weaponry and ordinance during training exercises or actual combat situations.

Clearly however, the degree of jeopardy to the body and life of a living combat solider will vary in severity and degree with these typically recurring circumstances and risk categories. Also, the precise nature of the threat that the military combat serviceman faces and the time duration for the risk of serious injury that one encounters in these different situations is often disparate and diverse. In view of our current geopolitical and economic world climates, it is deemed most useful and desirable to provide armored vehicles which can be prepared for safety and designed for protection against injury in military use instances, particularly under live-fire combat circumstances.

Among all the unpredictable conditions and uncertain predicaments in these arenas is the very real danger to life and limb caused by the unintentional exposure of the occupants of an armored vehicle to harm outside thereof. Often the only thing separating the military combat serviceman from such harm is the window or door of the vehicle in which he or she is riding. In many security door and window arrangements, especially those in armored vehicles, extremely simple and durable latching mechanisms are a necessity. Additionally, latching mechanisms that provide for on-demand at-will release and effortlessness egress/ingress are essential.

The present invention is directed to latching mechanisms for egress/ingress windows, doors, hatches, etc. These latching mechanisms can be advantageously employed in many different settings; in a diverse range of risk circumstances that vary greatly; and with particular modifications and engineering specifications which allow their immediate operation with a minimum of difficulty under a variety of combat and non-combat situations.

For example, as an alternative to entering and exiting an armored vehicle through a door, egress and ingress (under those circumstances which warrant it) through a window in an armored vehicle will be typically made under actual combat or high risk circumstances, and will be employed when the conventional means of entry and exit for the military vehicle (such as the doors) are non-functional, or it is too dangerous to use them under the given circumstances. It would therefore be advantageous to employ a simple to operate, secure and reliable window latching mechanism for just such occasions.

While the present invention is expected and intended to appear in multiple embodiments and in many different formats, some preferred examples and embodiments of the invention will be described in detail hereinafter, albeit with the clear understanding that the particulars of these embodiments are only illustrative and representative of the formats and applicability for the present invention; and that the true breadth of the invention is not limited in form nor restricted in scope to the exemplary embodiments provided herein.

Furthermore, it will be intuitive to those of skill in the art that a wide range of materials can be used in the making of certain parts of the various embodiments of the latching mechanisms, wherein each chosen material is well suited to provide particular properties.

It is expected and intended that the present invention will be most beneficial when introduced and used with motorized vehicles, particularly those vehicles used in high risk and/or military combat situations. It is also a valuable feature and prominent aspect of the present invention that the latching mechanisms can be employed as original equipment manufacture assemblies for almost any type of motored vehicle, movable carriage, or transporting conveyance.

### SUMMARY OF THE INVENTION

The present invention has multiple aspects, formats, and applications.

A first aspect of the invention provides a latching mechanism for securing a door or window of an armored vehicle comprising a spring-loaded latch assembly operatively connected to an interior surface of the armored vehicle door, the latch assembly comprising a latch and a square key stock both operatively connected to a cam, a handle assembly comprising at least one handle, wherein the handle assembly is operatively connected to an exterior surface of the armored vehicle door and wherein the at least one handle is operatively connected to the square key stock and a strike plate which is operatively connected to the armored vehicle comprising a roller wherein the latch rolls across said roller into a secured position when the door is closed.

A further aspect of the present invention provides a latching mechanism for securing a door or window of an armored vehicle comprising a lock assembly operatively connected to the interior of an armored door of the armored vehicle, a latch catch operatively connected to the lock assembly and the armored vehicle and a handle operatively connected to the locking mechanism wherein the lock assembly functions by moving the handle in a rotary motion, which rotates a square key stock to which a cam is attached that moves a dead bolt.

### BRIEF DESCRIPTION OF THE DRAWINGS

The aforementioned objects and advantages of the present invention, as well as additional objects and advantages thereof, will be more fully understood herein after as a result of a detailed description of preferred embodiments when taken in conjunction with the following drawings in which:

FIG. 1 is a front perspective view of a preferred embodiment of the latching mechanism of the present invention;

FIG. 2 is a rear perspective view of the latching mechanism of FIG. 1;

FIG. 3 is bottom perspective view of the latching mechanism of FIG. 1;

FIG. 4 is a partially broken away rear prospective view of the latching mechanism of FIG. 1;

FIG. 5 is a exploded front view of an alternative embodiment of a latching mechanism of the present invention;

FIG. 6 is an exploded rear view of the latching mechanism of FIG. 5; and

FIG. 7 is a front perspective view of an alternative embodiment of a latching mechanism of the present invention.

### DETAILED DESCRIPTION OF PREFERRED EMBODIMENTS

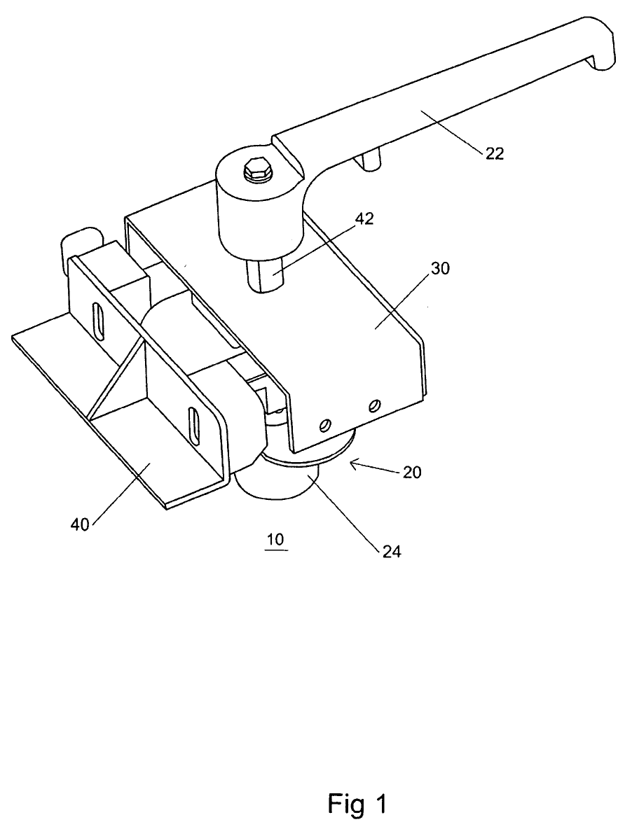

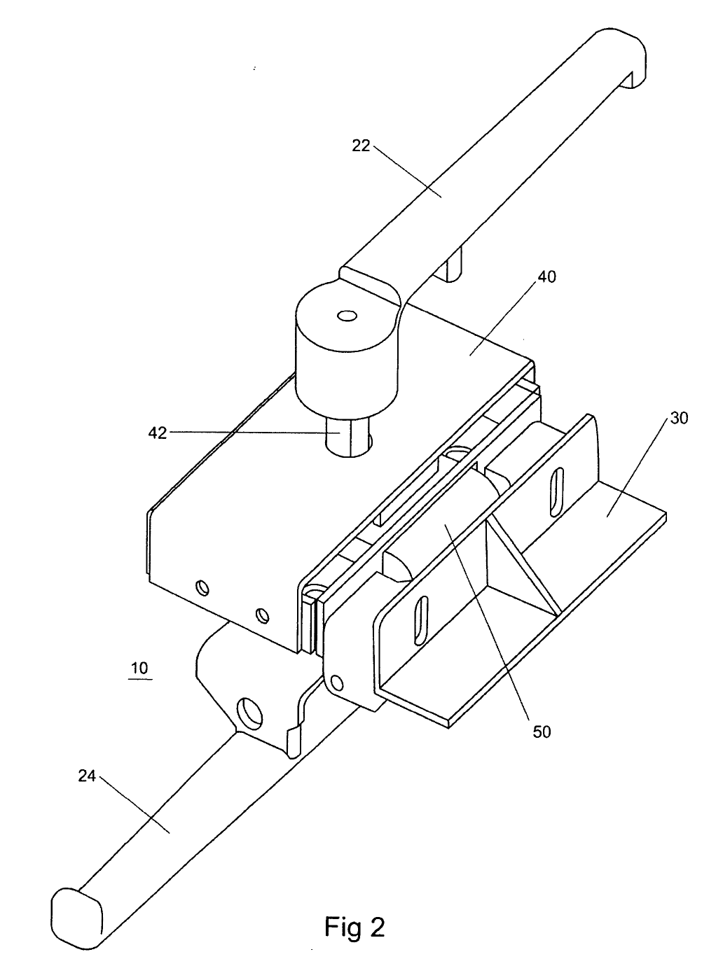

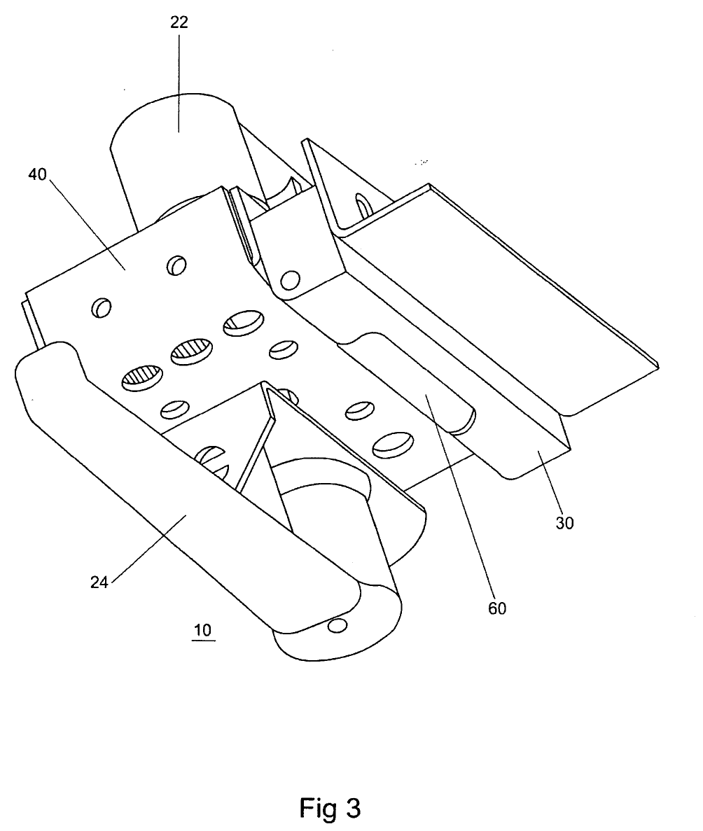

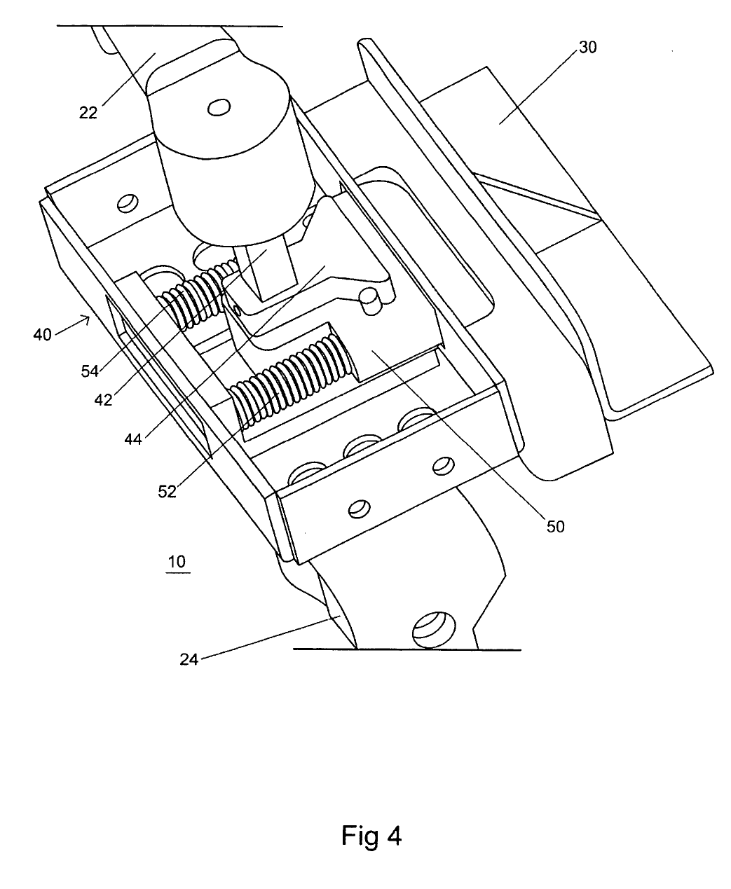

Referring to the accompanying figures and initially FIGS. 1 through 4 in particular, a latching mechanism 10 is shown. As illustrated, the latching mechanism 10 includes three major components, a handle assembly 20, which further includes an interior handle 22 and an exterior handle 24 for operating the latching mechanism, a strike plate assembly 30 and a latch assembly 40.

The latching mechanism 10, can be employed in multiple embodiments and will take commercial form in a variety of alternative constructions. It will be expressly understood and appreciated also that although the embodiments described below focus attention primarily upon doors and windows of armored vehicles per se, the present invention overtly encompasses and clearly includes other methods of egress and ingress into vehicles and buildings. For example, it is contemplated that the latching mechanism 10 may be used on any hatch or other hinged means for entering and exiting an armored vehicle such as a front windshield, emergency escape hatch, etc. In addition, the present invention may also be used with other vehicles, including but not limited to school buses, police cruisers, armored trucks, etc. Further, the present invention may also be employed with windows and doors in buildings and other structures.

In the present embodiment, the handle assembly 20 is preferably welded but may be otherwise secured to the exterior of object being latched, such as an armored door (not shown), the strike plate assembly 30 which is preferably welded but may be otherwise secured to a vehicle structure or an armored side plate (not shown) and the latch assembly 40 which is preferably bolted but may be otherwise attached to the interior of the armored door.

The latch assembly 40 further includes a square key stock 42 to which a cam 44 is operatively connected. In the present embodiment, the latch 50 functions by moving the interior handle 22 or the exterior handle 24 in a rotary motion about 25 degrees; this rotates the square key stock 42 which controls the cam 44 that retracts the latch 50. The latch 50 is spring-loaded by a pair of latch springs 52, 54, which allow the latch 50 to extend to its original position when interior handle 22 or the exterior handle 24 is released. The latch springs 52, 54 also move the handles 22, 24 back to their original locations.

In the present embodiment, the latching mechanism 10 allows an armored door or window to be latched shut by simply pushing the door or window closed. When the door is shut the latch 50 is operatively pushed back by the strike plate 30, which moves the latch away from the cam 44, thus allowing the door or window to close and latch without movement of the handles 22, 24. The strike plate 30 further includes a roller 60 mounted on it, which allows the latch 50 to roll on it when the door is closed. As shown, the latching mechanism 10 can be mounted on either a left hand or right hand opening door or window, since it is symmetrical.

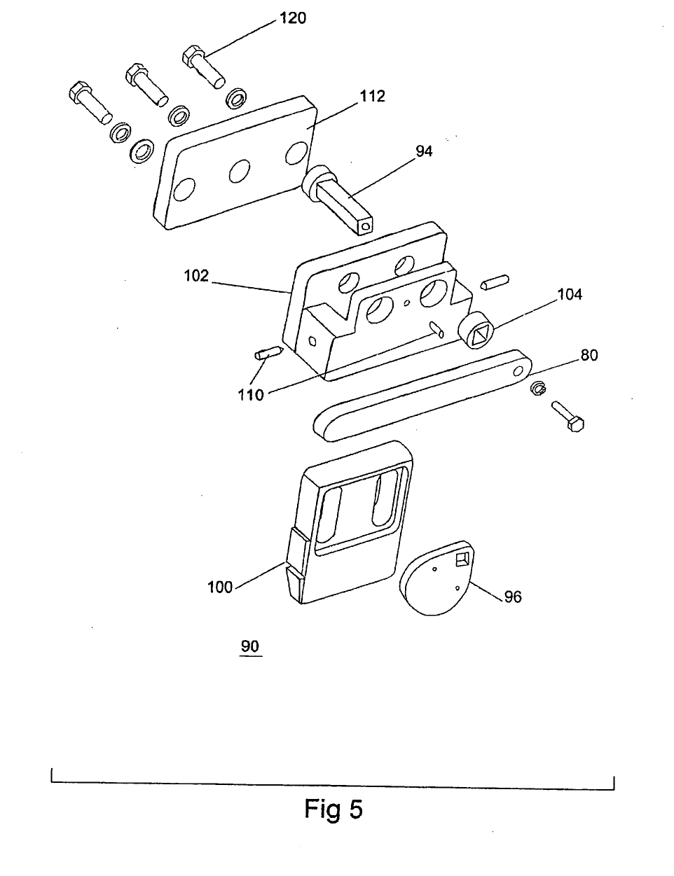

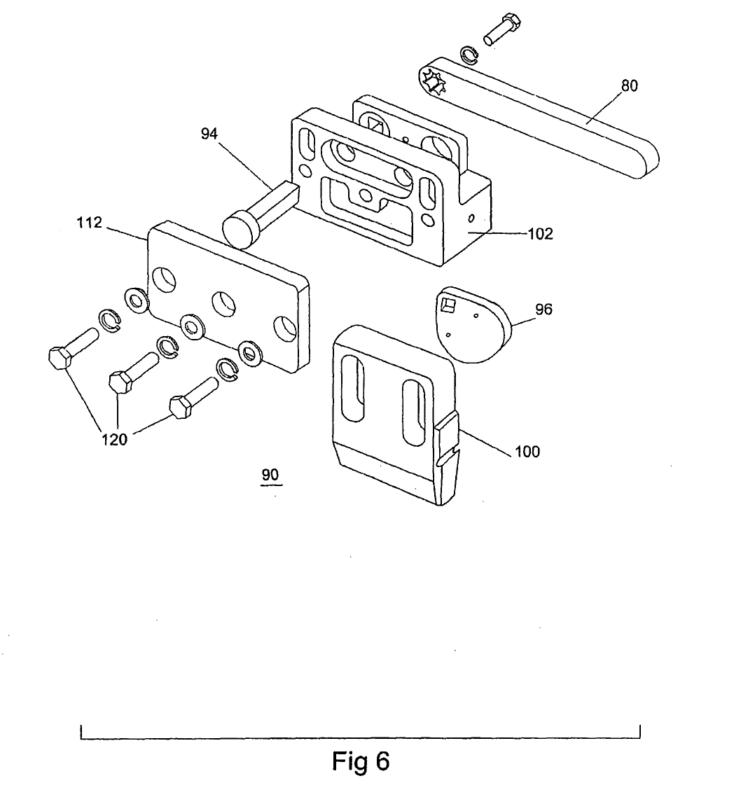

Referring now to FIGS. 5 and 6, and alternative embodiment of the present invention is shown. In this embodiment, a latch assembly 90 allows an armored door or window (not shown) to be locked shut by simply pushing a handle 80 on the latch assembly 90 approximately 90 degrees. In the present embodiment, the latch assembly 90 is bolted to the interior of the armored door with the three mounting bolts 120.

With the latch assembly 90 in a locked position, the door or window cannot be opened from the outside of the vehicle, thereby providing added protection to the occupants therein. In a rescue situation the latch assembly 90 can be released from the exterior of the armored vehicle by removing a set of three mounting bolts 120 that are accessible from the outside of the vehicle. In the present embodiment, the mounting bolts 120 are ⅜-16 bolts with a special head size that allows the use of the military's standard rescue wrench.

A latch catch (not shown), may be welded to the vehicle structure or the armored side plate (not shown). As previously discussed, the latch assembly 90 functions by moving the handle 80 in a rotary motion approximately 90 degrees; this rotates a square key stock 94 to which a cam 96 is attached that in turn moves a dead bolt 100.

The keystock 94 is supported in a body 102 of the latch assembly 90 and on a keystock support 104 in the front for smooth operation of the handle 80. The latch assembly 90 has three spring pins 110, which help to hold the dead bolt 100 and cam 96 in position so they will not vibrate loose during vehicle operation.

The latch assembly 90 is able to be oriented in any position on a door or window; it can also be changed from a left hand lock to a right hand lock by reversing the cam 96 and moving the keystock 94 to another hole on the body 102. Also the handle 80 can be mounted in 45-degree increments to allow for clearance issues on different vehicles. A shim 112 may be used to align the dead bolt 100 to the latch catch on different vehicles where the mounting of the latch catch may be affected by the cab structure, etc.

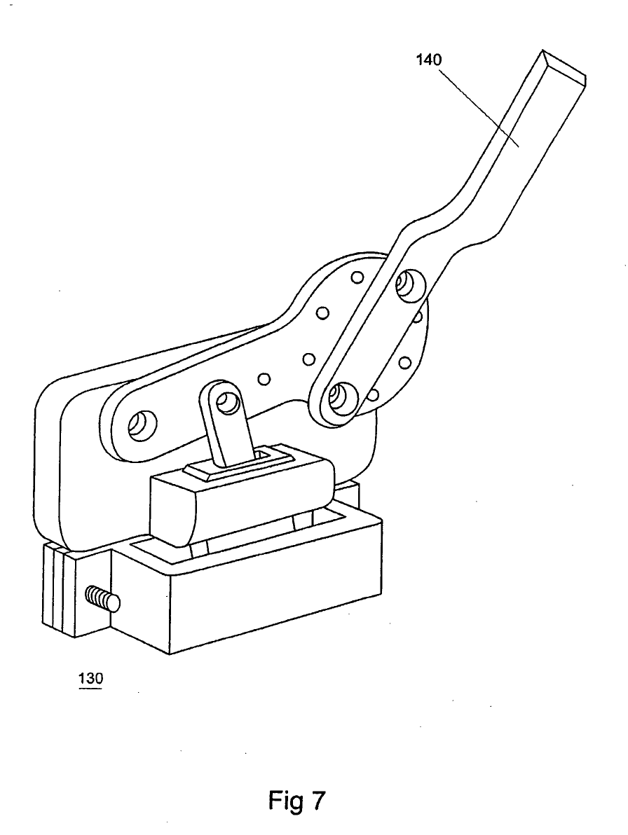

Referring now to FIG. 7, an alternative embodiment of the present invention is shown. In this embodiment, a latch mechanism 130 is shown. When a handle 140 is rotated into a locked position as shown, similar to the embodiment discussed above, the door or window to which the latch mechanism is secured cannot be opened from the outside of the vehicle, thereby providing added protection to the occupants therein.

Various aspects of the disclosed embodiments have been omitted to avoid obfuscation of the more salient features. By way of example, it will be understood that the locking latch mechanisms 90, 130 may be incorporated into other vehicles, buildings or assemblies.

Having thus described various embodiments of the present invention, it will now be evident that many modifications and additions are contemplated. Accordingly, the scope hereof is limited only by the appended claims and their equivalents.

What is claimed is:

1. A latching mechanism for securing a door or window of an armored vehicle comprising:
a. a spring-loaded latch assembly operatively connected to an interior surface of the armored vehicle door, the latch assembly comprising a latch and a square key stock both operatively connected to a cam;
b. a handle assembly comprising at least one handle, wherein the handle assembly is operatively connected to an exterior surface of the armored vehicle door and wherein the at least one handle is operatively connected to the square key stock; and
c. a strike plate which is operatively connected to the armored vehicle comprising a roller wherein the latch rolls across said roller into a secured position when the door is closed.

2. The latching mechanism of claim 1 wherein the spring-loaded latch assembly allows the latch to extend to its original position when the at least one handle is released.

3. The latching mechanism of claim 1 wherein the spring-loaded latch assembly operates to reposition the at least one handle back into an original position when released.

4. The latching mechanism of claim 1 wherein when the door is shut the latch is pushed back by the strike plate, which moves the latch away from the cam, thus allowing the door to close and latch without movement of the at least one handle.

5. The latching mechanism of claim 1 wherein the latching mechanism is symmetrical such that it may be mounted to either a left hand or a right hand opening door.

6. The latching mechanism of claim 1 wherein the latch assembly, the handle assembly and or the strike plate may be welded, bolted or otherwise fixedly secured to the armored vehicle.

7. The latching mechanism of claim 1 wherein the at least one handle operatively rotates about 25 degrees to operate the latching mechanism.

8. A latching mechanism for securing a door or window of an armored vehicle comprising:
a. a lock assembly operatively connected to the interior of an armored door of the armored vehicle;
b. a latch catch operatively connected to the lock assembly and the armored vehicle;
c. a handle operatively connected to the locking mechanism wherein the lock assembly functions by moving the handle in a rotary motion, which rotates a square key stock to which a cam is attached that moves a dead bolt.

9. The latching mechanism of claim 8 wherein the lock assembly further comprises a plurality of spring pins which help to hold the dead bolt and cam in position so they will not vibrate loose during vehicle operation.

10. The latching mechanism of claim 8 wherein the lock assembly is able to be oriented in any position on the door.

11. The latching mechanism of claim 8 wherein in a rescue situation the lock can be released from the exterior of the vehicle by removing a plurality of fastening means that are accessible from the outside of the vehicle.

12. The latching mechanism of claim 11 wherein the fastening means are a plurality of mounting bolts that are ⅜-16 bolts with a special head size that allows the use of a military's standard rescue wrench.
